(19) United States
(12) Patent Application Publication
(10) Pub. No.: US 2026/0092772 A1
(43) Pub. Date: Apr. 2, 2026

(54) METHOD FOR MEASURING AT LEAST ONE CROSS-SECTIONAL DIMENSION OF A CYLINDRICAL HOLLOW BODY

(71) Applicant: Schott AG, Mainz (DE)

(72) Inventors: Alexander Hecht, Mitterteich (DE); Andreas Veres, Mitterteich (DE); André Witzmann, Waldershof (DE); Thomas Hofbeck, Mitterteich (DE)

(73) Assignee: Schott AG, Mainz (DE)

(21) Appl. No.: 19/345,568

(22) Filed: Sep. 30, 2025

(30) Foreign Application Priority Data
Sep. 30, 2024 (EP) 24203587.1

(51) Int. Cl. G01B 11/28; G01B 9/02015; G01B 9/02017; G01B 11/06

(52) U.S. Cl. CPC G01B 11/285; G01B 9/02019; G01B 9/02027; G01B 11/06

(57) ABSTRACT

A method for measuring at least one cross-sectional dimension of a cylindrical hollow body having a wall surrounding a lumen, a longitudinal axis, an inner surface and an outer surface includes: directing a light beam along a travel path from an interferometric device towards the outer surface, such that at least intermittently at least a portion of the light beam hits the outer surface of the hollow body; receiving a portion of light reflected at the outer surface and receiving a portion of light reflected at the inner surface along the travel path at the interferometric device; obtaining at least one cross-sectional dimension of the hollow body based on an interferometric measurement of the portion of light reflected at the outer surface and/or the portion of light reflected at the inner surface; and varying an orientation of the travel path of the light beam towards the hollow body.

### CROSS REFERENCE TO RELATED APPLICATIONS

This application claims priority to European Patent Application No. 24203587.1 filed on Sep. 30, 2024, which is incorporated in its entirety herein by reference.

### BACKGROUND OF THE INVENTION

### 1. Field of the Invention

This disclosure relates to a method for measuring at least one cross-sectional dimension of a cylindrical hollow body, an apparatus for measuring at least one cross-sectional dimension of a cylindrical hollow body, and a cylindrical hollow body. The method and apparatus provide for a more efficient measurement of geometrical properties of a cylindrical hollow body.

### 2. Description of the Related Art

Cylindrical hollow bodies in the form of tubes are useful for the storage of pharmaceuticals when manufactured into pharmaceutical containers. The demands and standards for pharmaceutical containers are constantly increasing, aiming to provide and guarantee the quality of the transported pharmaceutical and to allow unhindered inspection of the stored pharmaceuticals, optionally with the naked eye.

Methods for measuring glass tubes and polymer tubes with respect to their geometric properties are known in the art. Different methods are used to determine the outer diameter, the inner diameter and the wall thickness. For the measurement of the outer diameter, transmission light methods are used in which the cast shadow is recorded by a camera and the obtained images are analyzed to derive the outer diameter. The wall thickness is typically measured by chromatic confocal methods and interferometry methods. Both methods are suitable for measuring the wall thickness provided that the measurement axis of the respective measuring head is orthogonally oriented to the tube surface and thus runs through the centre of the tube cross-section. If that requirement is not met, a chromatic-confocal measurement method will result in measurement errors, and an interferometry method will suffer from signal breaks. Deviations from an orthogonal alignment in the said two methods may result from tube movements and/or tube vibrations. Said problem is most prominent in the case of glass tubes with increasingly curved surfaces, i.e., glass tubes with a small outer diameter, for which it is particularly difficult and sometimes practically impossible to establish an orthogonal alignment of the measurement axis with respect to the tube surface. Whereas there is no direct method for the measurement of the inner diameter, the inner diameter is typically calculated from the outer diameter and the wall thickness.

WO 2012/117353 A2 discloses an apparatus and a method for measuring the thickness of a wall of a transparent object. The wall comprises a transparent material arranged between a proximal interface, set between an environment and the transparent material, and a distal interface, set between said transparent material and the environment. The apparatus comprises a source of a starting light radiation and a means for focusing it, to obtain an entering light radiation directed towards the wall that hits the proximal interface of the wall of the object and is in part reflected, to generate a first reflected radiation. A part of the entering light radiation that is transmitted through the transparent material hits upon the distal interface and is in turn reflected and crosses in an opposite direction the transparent material through the proximal interface to generate a second reflected radiation. A collected radiation given by overlapping the first and second reflected radiations have a difference of intensity that is configured to obtain an interference, which allows determining the thickness of the wall. The means for focusing comprises a lens means that have two main meridians orthogonal to each other, such that the entering light radiation is focused on a first virtual focus in the first meridian plane, and on a second virtual focus in the second meridian plane. In this way, the collected radiation is substantially independent from possible movements of the transparent object which allows a reliable and robust measurement with respect to fluctuations and vibrations of the object.

WO 2021/024127 A1 discloses an apparatus and an optical detection method for the non-contact dimensional measuring of the inner diameter of a tube along a production line, wherein the apparatus comprises at least one thickness measure sensor of the optical type and at least one diameter measure sensor for measuring the outer diameter of the tube. Each diameter measure sensor and at least one thickness measure sensor are constrained to a supporting body to be radially oriented with respect to the geometric axis of the tube. The thickness measure sensor measures the thickness at a tube section belonging to the outer diameter of the tube detected by the diameter measure sensor. The thickness and diameter measure sensors are synchronized for measuring simultaneously. The inner diameter of the tube is calculated as the difference between the outer diameter and the thickness of the tube detected. The supporting body on which or in which the thickness measure sensors and diameter measure sensors are fixed ensures that the measures are on the same axis orthogonal to the geometric axis of the tube.

There still remains a desire to provide an apparatus and a detection method which are more efficient than the ones described in the art.

### SUMMARY OF THE INVENTION

In some embodiments provided according to the present disclosure, a method for measuring at least one cross-sectional dimension of a cylindrical hollow body is provided. The hollow body having a wall surrounding a lumen, a longitudinal axis, an inner surface and an outer surface. The method includes: providing the hollow body; directing a light beam along a travel path from an interferometric device towards the outer surface of the hollow body, such that at least intermittently at least a portion of the light beam hits the outer surface of the hollow body; receiving a portion of light reflected at the outer surface and receiving a portion of light reflected at the inner surface along the travel path at the interferometric device; obtaining at least one cross-sectional dimension of the hollow body based on an interferometric measurement of the portion of light reflected at the outer surface and/or the portion of light reflected at the inner surface; and varying an orientation of the travel path of the light beam towards the hollow body.

In some embodiments provided according to the present disclosure, an apparatus for measuring at least one cross-sectional dimension of a cylindrical hollow body includes at least one interferometric device and a scanner that is arrangeable to direct an emitted light beam from the at least one interferometric device along a travel path towards an outer surface of the hollow body. The scanner is capable of varying an orientation of the travel path of the emitted light beam.

In some embodiments provided according to the present disclosure, a cylindrical hollow body has a longitudinal axis, an outer surface and an inner surface. The hollow body has a first wall thickness (WT1), an inner diameter (ID), and a second wall thickness (WT2). The first wall thickness WT1, the inner diameter ID, and the second wall thickness WT2 are measurable along any straight line which stands perpendicular on the longitudinal axis, and which straight line hypothetically cuts through the hollow body. The hollow body has an outer diameter (OD) of 6 mm or less and the inner diameter is 5 mm or less. An absolute difference between the first wall thickness WT1 and the second wall thickness WT2 is less than 0.01 mm and/or the inner diameter ID has a tolerance of less than 0.01 mm.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1A illustrates a cross-section of a hollow body provided according to this disclosure;

FIG. 1B illustrates a cross-section of a further hollow body provided according to this disclosure;

FIG. 2A illustrates a measurement setup according to the prior art;

FIG. 2B illustrates the measurement setup according to the prior art, as depicted in FIG. 2A;

FIG. 3A illustrates a measurement setup provided according to this disclosure; and

FIG. 3B illustrates a further measurement setup provided according to this disclosure.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

In one aspect, this disclosure provides a method for measuring at least one cross-sectional dimension of a cylindrical hollow body, the hollow body having a wall surrounding a lumen, a longitudinal axis, an inner surface and an outer surface, the method comprising: providing a cylindrical hollow body, directing a light beam along a travel path from an interferometric device towards the outer surface of the hollow body, such that at least intermittently at least a portion of the light beam hits the outer surface of the hollow body, receiving a portion of light reflected at the outer surface and receiving a portion of light reflected at the inner surface along the travel path at the interferometric device, obtaining at least one cross-sectional dimension of the hollow body based on an interferometric measurement of the portion of light reflected at the outer surface and/or the portion of light reflected at the inner surface, and varying an orientation of the travel path of the light beam towards the hollow body.

Interferometric measurements rely on receiving at least two distinct light beams with a different light path. The two light beams may either interfere constructively or interfere destructively. The measurement of at least one cross-sectional dimension of a cylindrical hollow body may be compromised when the initial light beam does not reach the outer surface of the hollow body at a suitable angle in order to receive a portion of light reflected at the outer surface and to receive a portion of light reflected at the inner surface along the travel path at the interferometric device. In other words, if the initial light beam reaches the outer surface of the hollow body at an angle which is too far off an orthogonal angle, the said portions of light reflected at the outer surface and at the inner surface may not be detected. The described problem may heavily manifest itself on hollow bodies with a small outer diameter which would need to be perfectly mounted for the desired measurement. The described problem is also pronounced during measurements of hollow bodies in or along a production line, because mechanical vibrations may lead to signal fluctuations or even lack of signal at the detector. In view of that, the inventors developed a method which provides that a portion of light reflected at the outer surface and a portion of light reflected at the inner surface along the travel path at the interferometric device can be received even in the presence of mechanical vibrations of the hollow bodies. The developed method also does not require any specific mounting of the hollow body, as long as at least intermittently at least a portion of the light beam hits the outer surface of the hollow body. Accordingly, the method is characterized in that it comprises varying an orientation of the travel path of the light beam towards the hollow body. Said feature provides that at least intermittently at least a portion of the light beam hits the outer surface of the hollow body at an angle which is sufficient to receive a portion of light reflected at the outer surface and receiving a portion of light reflected at the inner surface along the travel path at the interferometric device. By virtue of this feature, the incidental number of (successful) detections at the interferometric device is increased. The method provided according to this disclosure is thus more reliable and more robust. The method provided according to this disclosure also provides more data points for measuring at least one cross-sectional dimension of a cylindrical hollow body even in the presence of mechanical vibrations, e.g., in a production line, and/or on imperfectly mounted cylindrical hollow bodies. Provided that a certain data throughput is desired, the method provided according to this disclosure is also faster because it provides more successful detection events.

In a second aspect, this disclosure provides an apparatus for measuring at least one cross-sectional dimension of a cylindrical hollow body, the apparatus comprising at least one interferometric device, and a scanner. The scanner is arrangeable to direct an emitted light beam from the at least one interferometric device along a travel path towards an outer surface of the hollow body and the scanner is capable of varying an orientation of the travel path of the emitted light beam.

The disclosed apparatus solves the problems of the prior art and provides a more reliable and more robust measurement of cylindrical hollow bodies.

For interferometry measurements an essentially orthogonal alignment of the measuring axis to the tube surface is decisive to obtain a measurement value which originates from reflected light at each of the encountered interfaces, i.e., in case of a glass tube, at a first outer interface air/glass, at a first inner interface glass/air, at a second inner interface air/glass, and at a second outer interface glass/air. Each interferometry method specifies a relatively small acceptance angle. For example, the acceptance angle of a Precitec CHRocodile sensor is 2°. If the measurement axis deviates more than about half of the acceptance angle from a mathematically perfect orthogonal alignment to the tube surface, no measurement value is obtained.

By virtue of the scanner which can vary an orientation of the travel path of the emitted light beam more data points for measuring the at least one cross-sectional dimension of the cylindrical hollow body can be detected, even in the presence of mechanical vibrations and/or on imperfectly mounted cylindrical hollow bodies. The scanner varies the orientation of the travel path of the emitted light in such a way that a nearly orthogonal alignment of the measuring axis with respect to the surface of the hollow body is achieved more often than in a case where the travel path of the emitted light is static.

Both the method and apparatus provided according to this disclosure allow an interferometric measurement on a cylindrical hollow body which experiences imperfect orientation with respect to the light beam for example due to mechanical vibrations, e.g., resulting from the transport along a production line. The method and apparatus may also provide a direct measurement of a first wall thickness, an inner diameter, a second wall thickness, and/or an outer diameter along a single measurement axis. The method and apparatus are particularly suited for the measurement of glass tubes and polymer tubes with relatively small outer diameters.

In a third aspect, this disclosure provides a cylindrical hollow body having a longitudinal axis, an outer surface and an inner surface, the hollow body having a first wall thickness WT1, an inner diameter ID, and a second wall thickness WT2. The first wall thickness WT1, the inner diameter ID and the second wall thickness WT2 are measurable along any straight line which stands perpendicular on the longitudinal axis, and which straight line hypothetically cuts through the hollow body. The hollow body has an outer diameter OD of 6 mm or less and an inner diameter ID of 5 mm or less. The absolute difference between the first wall thickness WT1 and the second wall thickness WT2 is less than 0.01 mm, or less than 0.001 mm and/or the inner diameter has a tolerance of less than 0.01 mm, or less than 0.001 mm.

The method and apparatus provided according to this disclosure helps provide cylindrical hollow bodies with excellent dimensional accuracy by allowing in-process control of relevant production parameters.

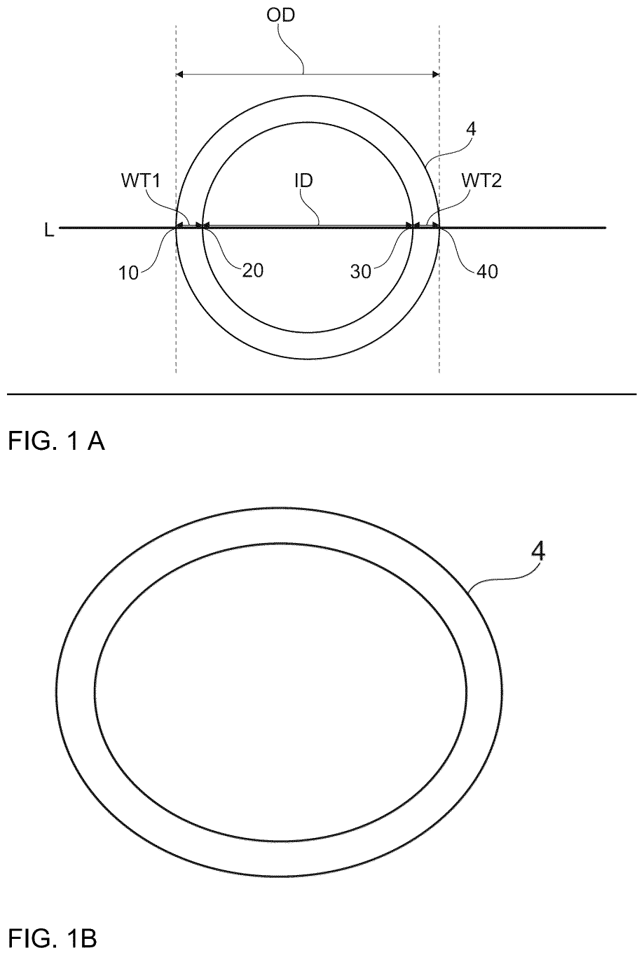

Referring now to the drawings, FIG. 1A shows a cross-section of a hollow body 4 provided according to this disclosure indicating a first wall thickness WT1, a second wall thickness WT2, an inner diameter ID and an outer diameter OD along a straight line L passing through a diameter of the cross-section. Fictitious intersection points are denoted ‘10’, ‘20’, ‘30’ and ‘40’ along a travel path of a light beam.

FIG. 1B shows a cross-section of a hollow body provided according to this disclosure with an inner cross-section and an outer cross-section, wherein the inner cross-section can be approximated as an inner ellipse, and wherein the outer cross-section can be approximated as an outer ellipse.

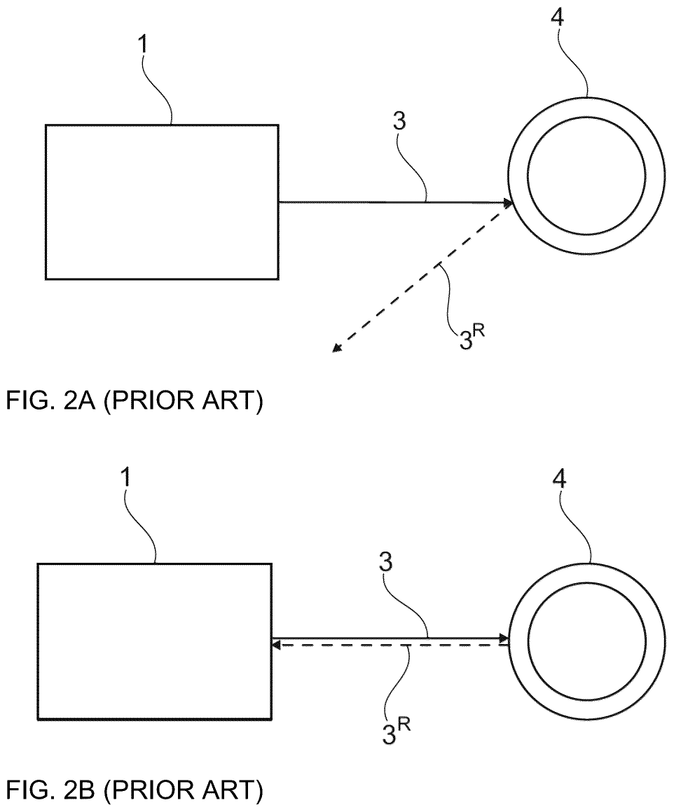

FIG. 2A shows a measurement setup provided according to the prior art, indicating an interferometric device 1 emitting a light beam 3 towards the outer surface of a hollow body 4. A portion of the light beam 3 hits the outer surface of the hollow body 4. However, as indicated, if the axis of the light beam 3 is substantially off the corresponding diameter of the cross-section of the hollow body 4, reflected light 3^{R} will not reach the interferometric device 1.

FIG. 2B shows the measurement setup provided according to the prior art, as depicted in FIG. 2A. Only if the axis of the light beam 3 is substantially parallel to the corresponding diameter of the cross-section of the hollow body 4, reflected light 3^{R} will reach the interferometric device 1.

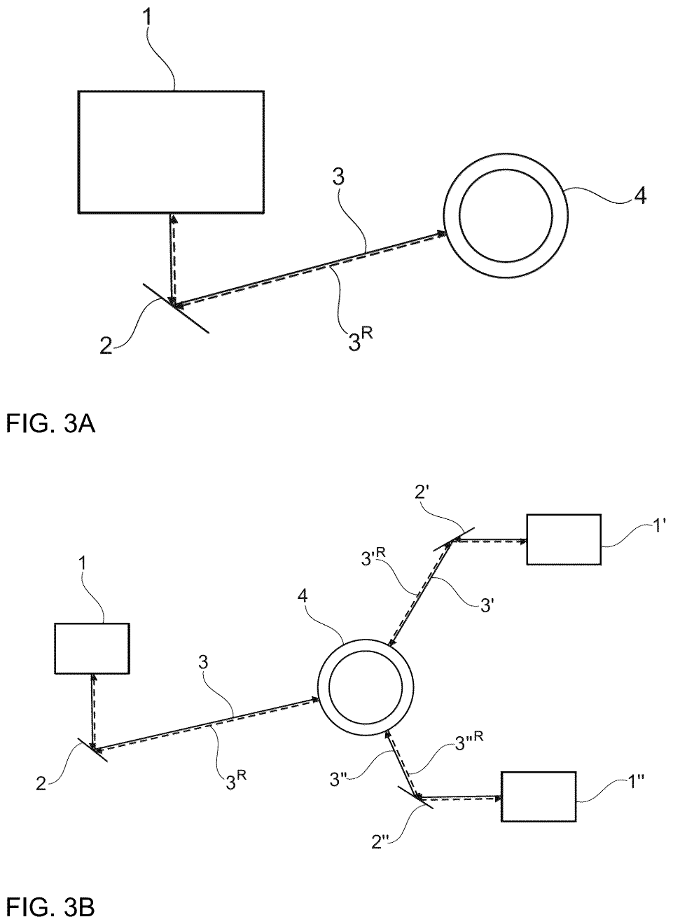

FIG. 3A shows a measurement setup provided according to this disclosure, indicating an interferometric device 1, a scanner 2, the interferometric device 1 emitting a light beam 3 towards the outer surface of a hollow body 4. A portion of the light beam 3 hits the outer surface of the hollow body. By virtue of the scanner, the axis of the light beam 3 can be varied, such that there are instances where the light beam 3 is substantially parallel to a corresponding diameter of the cross-section of the hollow body 4. Hence, reflected light 3^{R} will reach the interferometric device 1.

FIG. 3B shows a further measurement setup provided according to this disclosure with an interferometric device 1, a scanner 2, the interferometric device 1 emitting a light beam 3 towards the outer surface of a hollow body 4, a second interferometric device 1′, a second scanner 2′, the second interferometric device l′ emitting a second light beam 3′ towards the outer surface of the hollow body 4, a third interferometric device 1″, a third scanner 2″, the third interferometric device 1″ emitting a third light beam 3″ towards the outer surface of the hollow body 4. By virtue of the scanners 2, 2′, 2″, the axes of the light beams 3, 3′, 3″ can be varied, such that there are instances where the light beams 3, 3′, 3″ are substantially parallel to a corresponding diameter of the cross-section of the hollow body 4. Hence, reflected light 3^{R}, 3′^{R}, 3″^{R} will reach the interferometric device 1.

### METHOD

In one aspect, this disclosure provides a method for measuring at least one cross-sectional dimension of a cylindrical hollow body, the hollow body having a wall surrounding a lumen, a longitudinal axis, an inner surface and an outer surface, the method comprising:
Providing a cylindrical hollow body,
Directing a light beam along a travel path from an interferometric device towards the outer surface of the hollow body, such that at least intermittently at least a portion of the light beam hits the outer surface of the hollow body,
Receiving a portion of light reflected at the outer surface and receiving a portion of light reflected at the inner surface along the travel path at the interferometric device,
Obtaining at least one cross-sectional dimension of the hollow body based on an interferometric measurement of the portion of light reflected at the outer surface and/or the portion of light reflected at the inner surface, and
Varying an orientation of the travel path of the light beam towards the hollow body.

According to this disclosure, the cylindrical hollow body has a wall surrounding a lumen, a longitudinal axis, an inner surface and an outer surface. Theoretically, the cylindrical hollow body may take the form of a mathematically perfect cylinder. However, the cylindrical hollow body may have an overall cylindrical shape with technically acceptable deviations regarding its inner diameter, its outer diameter and the thickness of the wall along its length. The cylindrical hollow body may be a finite cylinder or may represent a portion of a larger body, wherein the said portion has an overall cylindrical shape with the said technically acceptable deviations. The wall shall be understood as a physical barrier of a certain wall thickness, wherein the physical barrier may be constructed of different materials, such as, e.g., glass or polymer. The lumen shall be understood as an inner volume which may be evacuated, or filled with air, or filled with a gas mixture.

In some embodiments of the method, the at least one cross-sectional dimension of the hollow body includes a first wall thickness WT1, optionally also includes an inner diameter ID, and optionally includes also a second wall thickness WT2, and optionally also includes the outer diameter OD.

In some embodiments of the method, the at least one cross-sectional dimension of the hollow body includes an outer diameter OD.

FIG. 1 shows a cross-section of the hollow body provided according to this disclosure. Any diameter passing through the cross-section will fictitiously cut the hollow body across the wall on a left side and a right side, from an arbitrary viewpoint along the longitudinal axis, which matches a first wall thickness WT1 and a second wall thickness WT2. The fictitious intersection points are denoted ‘10’, ‘20’, ‘30’ and ‘40’ along the travel path of the light beam. The distance between the intersection points ‘20’ and ‘30’ of the said diameter at the inner surface of the wall represents the inner diameter ID. The distance between the intersection points ‘10’ and ‘40’ of the said diameter at the outer surface of the wall represents the outer diameter OD. For a mathematically perfect cylindrical body, the outer diameter could be calculated as OD=WT1+ID+WT2. However, according to this disclosure, the outer diameter is accessible through measurement of a cylindrical hollow body having an overall cylindrical shape with technically acceptable deviations regarding its inner diameter, and the thickness of the wall along its length, so that the mathematical equation may not be strictly fulfilled for all real-world scenarios.

The method may rely on receiving a portion of light reflected at the outer surface and receiving a portion of light reflected at the inner surface along the travel path at the interferometric device in order to calculate the at least one cross-sectional dimension of the hollow body. Provided that a sufficient portion of reflected light is received from a first intersection point ‘10’ and a second intersection point ‘20’, the first wall thickness can be measured. Provided that a further sufficient portion of reflected light is received from a third intersection point ‘30’, the inner diameter can be measured. Provided that yet a further sufficient portion of reflected light is received from a fourth intersection point ‘40’, the second wall thickness and the outer diameter can be measured.

The method may also rely on receiving a portion of light reflected at the outer surface. For example, if the hollow body is filled with a medium which is close or matched in refractive index with respect to the material of the hollow body, a sufficient portion of reflected light may be received from a first intersection point ‘10’ and a fourth intersection point ‘40’, so that the outer diameter can be measured. Accordingly, the method allows measuring, e.g., vials filled with a water-glycerine solution, optionally containing one or more pharmaceutical ingredients and/or other ingredients.

The method may be advantageous because the step of varying an orientation of the travel path of the light beam towards the hollow body provides that sufficient portions of reflected light may be detected from any or all of the fictitious intersection points, i.e., the first intersection point ‘10’, the second intersection point ‘20’, the third intersection point ‘30’ and the fourth intersection point ‘40’ along the travel path of the light beam. By virtue of said feature, the probability of detecting sufficient portions of reflected light is increased compared to a static situation in which the travel path of the light beam towards the hollow body is permanent with respect to the reference frame of the interferometric device.

In some embodiments of the method, the hollow body is a glass tube or a glass tube strand, wherein the glass tube or glass tube strand is optionally conveyed from a production line, such as a Vello or down-draw method, or alternatively a Danner method, in a direction substantially parallel to the glass tube strand's longitudinal axis, and/or wherein the glass tube or glass tube strand is rotated around the glass tube's longitudinal axis and/or wherein the glass tube is moved in translation to the glass tube's longitudinal axis.

In some embodiments, the hollow body is made from a glass tube, such as, e.g., a vial, an ampoule, a syringe. The glass tube may also be a cut glass tube section. In some embodiments, the glass tube may have two open ends. In some embodiments, the glass tube may have two closed ends. In some embodiments, the glass tube may have one open end and one closed end.

In some embodiments, the hollow body is a glass tube strand which is obtainable from a production line, such as a Vello or down-draw method, or alternatively a Danner method. In said production processes, an “infinitely long” glass tube strand is drawn from a glass melt. Typically, after passing a roller track and a subsequent drawing machine, glass tube sections may be obtained by cutting the glass tube strand. In the said industrial production processes, the glass tube sections are often approximately 1.5 m long. The method provided according to this disclosure is applicable to glass tube strands before and/or after passing a roller track and/or after passing a subsequent drawing machine.

The method provided according to this disclosure may be performed on a fixed hollow body or a moving hollow body. A fixed hollow may, e.g., be firmly clamped, or moving with respect to the reference frame of the interferometric device. Accordingly, glass tube sections, vials, ampoules and/or syringes may be measured when mounted or they may be moving, i.e., translating or rotating. In some embodiments of the method, glass tube sections, vials, ampoules and/or syringes may be rotated around their longitudinal axis. In some embodiments of the method, glass tube sections, vials, ampoules and/or syringes may be transported along their longitudinal axis. In some embodiments of the method, the glass tube strand is rotated around its longitudinal axis. In some embodiments of the method, the glass tube strand is transported along its longitudinal axis.

The method provided according to this disclosure may also be advantageous for measurements in a fixed situation, because a mounted glass tube or glass tube strand is unlikely to be perfectly oriented to obtain sufficient portions of reflected light from the first intersection point ‘10’, the second intersection point ‘20’, optionally also the third intersection point ‘30’ and optionally also the fourth intersection point ‘40’, in the absence of varying an orientation of the travel path of the light beam towards the hollow body. Varying the orientation of the travel path of the light beam towards the hollow body increases the chance of detecting sufficient portions of reflected light from said fictitious intersection points. This feature also provides for reducing the measurement time because time-consuming adjustments of the orientation of specimen or measuring device are not necessary.

In some embodiments of the method, the hollow body comprises or consists of a glass composition or a polymer material, wherein optionally the glass composition is transparent at a wavelength, or alternatively at a wavelength range, of the light beam, wherein optionally the polymer material is transparent at a wavelength, or alternatively at a wavelength range, of the light beam.

Within this disclosure, a “transparent” glass composition, respectively, a transparent polymer material, has a transmittance of at least 30% for at least one measurement wavelength, e.g., in the wavelength range of 300 to 5000 nm, measured at the wall thickness of the cylindrical hollow body (in particular WT1), and optionally a transmission haze value of less than 1.0%, wherein the transmission haze value refers to the amount of light that is subject to scattering at an angle greater than 2.5° from normal, measured according to ASTM D1003-13 (Procedure A-Hazemeter), using CIE Standard Illuminant C. In an alternative embodiment, a “transparent” glass composition, respectively, a transparent polymer material, may have a transmittance of at least 50%, or at least 70%, for at least one measurement wavelength, measured at the wall thickness of the cylindrical hollow body (in particular WT1), and optionally a transmission haze value of less than 1.0%.

In some embodiments, a glass composition or a polymer material provided according to this disclosure have a transmittance of at least 30% in the wavelength range of 300 to 750 nm, measured at a thickness of 1 mm. In some embodiments, a glass composition or a polymer material provided according to this disclosure have a transmittance of at least 50% in the wavelength range of 300 to 750 nm, measured at a thickness of 1 mm. In some embodiments, a glass composition or a polymer material provided according to this disclosure have a transmittance of at least 70% in the wavelength range of 300 to 750 nm, measured at a thickness of 1 mm. In some embodiments, a glass composition or a polymer material provided according to this disclosure have a transmittance of at least 90% in the wavelength range of 300 to 750 nm, measured at a thickness of 1 mm.

In some embodiments, a glass composition or a polymer material provided according to this disclosure have a transmittance of at least 30% in the wavelength range of 750 to 2500 nm, measured at a thickness of 1 mm. In some embodiments, a glass composition or a polymer material provided according to this disclosure have a transmittance of at least 50% in the wavelength range of 750 to 2500 nm, measured at a thickness of 1 mm. In some embodiments, a glass composition or a polymer material provided according to this disclosure have a transmittance of at least 70% in the wavelength range of 750 to 2500 nm, measured at a thickness of 1 mm. In some embodiments, a glass composition or a polymer material provided according to this disclosure have a transmittance of at least 90% in the wavelength range of 750 to 2500 nm, measured at a thickness of 1 mm.

In some embodiments, the hollow body has a surface roughness on the outer surface and the inner surface of 1 nm to 5000 nm, or 10 nm to 3000 nm, or 50 nm to 2000 nm, or 70 nm to 1000 nm, or 100 nm to 500 nm, determined according to ISO 25178-2:2012. In some embodiments, the hollow body has a surface roughness on the outer surface and the inner surface of 1 nm or more, or 10 nm or more, or 50 nm or more, or 70 nm or more, or 100 nm or more. In some embodiments, the hollow body has a surface roughness on the outer surface and the inner surface of 5000 nm or less, or 3000 nm or less, or 2000 nm or less, or 1000 nm or less, or 500 nm or less.

In some embodiments of the method, the light beam is a focused light beam which is focused on the outer surface of the hollow body, wherein the focused light beam optionally comprises or consists of coherent, monochromatic light. Advantageously, using a focused light beam provides a larger intensity upon receiving a portion of light reflected at the outer surface and upon receiving a portion of light reflected at the inner surface. Likewise, a portion of reflected light received from the third intersection point ‘30’, and the fourth intersection point ‘40’, may be detected with a larger intensity. Thereby, the number of successful detection events may be increased.

In some embodiments of the method, the light beam is a collimated light beam. This option hypothetically provides that equal portions of light may reach the first intersection point ‘10’, the second intersection point ‘20’, the third intersection point ‘30’, and the fourth intersection point ‘40’ when neglecting absorption effects.

In some embodiments of the method, the light beam comprises or consists of coherent, monochromatic light.

In some embodiments of the method, the step of directing a light beam is effected by a scanner which is operable at a mechanical scanning frequency between 10 and 1000 Hz, optionally between 200 and 300 Hz, and/or wherein the apparatus is operable at a data sampling frequency of up to 100 kHz, optionally between 60 to 70 KHz.

In some embodiments, the scanner operates in a one-dimensional fashion, wherein the scanner is mounted in such a way that a vector of the light beam directed towards the outer surface of the hollow body and a vector parallel to the longitudinal axis of the cylindrical hollow body are perpendicular to each other. This alignment ensures that upon scanning there are instances where the light beam directed towards the outer surface of the hollow body subtends the longitudinal axis of the cylindrical hollow body perpendicularly, which allows receiving a portion of light reflected at the outer surface and receiving a portion of light reflected at the inner surface along the travel path at the interferometric device.

In some embodiments, the scanner operates in a two-dimensional fashion. Two-dimensional scanning can bear the advantage that the mounting of the scanner does not require any specific alignment of the light beam directed towards the outer surface of the hollow body. Two-dimensional scanning, by virtue of its nature, ensures that upon scanning there are instances where the light beam directed towards the outer surface of the hollow body subtends the longitudinal axis of the cylindrical hollow body perpendicularly, which allows receiving a portion of light reflected at the outer surface and receiving a portion of light reflected at the inner surface along the travel path at the interferometric device.

In some embodiments of the method, the step of obtaining the at least one cross-sectional dimension of the hollow body records a timestamp for each value obtained. Statistical data can thereby be generated and further analyzed. For example, in a fixed situation, wherein the hollow body is mounted in a fixed position, e.g., a glass tube or a glass tube strand, several values for the at least one cross-sectional dimension, i.e., WT1, optionally also ID, and optionally also WT2, as well as OD, may be obtained at one and the same diagonal axis within a fixed cross-section of the hollow body. In case hollow body is rotated, e.g., the glass tube or glass tube strand is rotated around the glass tube's longitudinal axis, several values for WT1, optionally also ID, WT2, and OD, may be obtained for different diagonal axes within a fixed cross-section of the hollow body. In cases, wherein the glass tube or glass tube strand is conveyed from a production line, such as a Vello or down-draw method, or alternatively a Danner method, in a direction substantially parallel to the glass tube strand's longitudinal axis, and/or wherein the glass tube is moved in translation to the glass tube's longitudinal axis, individual values for the at least one cross-sectional dimension, i.e., WT1, optionally also ID, and optionally also WT2, as well as OD, may be obtained from different cross-sections of the hollow body.

In some embodiments of the method, wherein the hollow body is a glass tube or a glass tube strand, the conveying of the glass tube proceeds at a velocity between 0.001 and 6 m s⁻¹, or 0.005 and 5 m s⁻¹, or 0.01 and 4 m s⁻¹, or 0.05 and 3 m s⁻¹, or 0.1 and 2 m s⁻¹. In some embodiments, the conveying of the glass tube proceeds at a velocity of 0.001 m s⁻¹ or more, or 0.005 m s⁻¹ or more, or 0.01 m s⁻¹ or more, or 0.05 m s⁻¹ or more, or 0.1 m s⁻¹ or more. In some embodiments, the conveying of the glass tube proceeds at a velocity of 6 m s⁻¹ or less, or 5 m s⁻¹ or less, or 4 m s⁻¹ or less, or 3 m s⁻¹ or less, or 2 m s⁻¹ or less.

In some embodiments, the wall of the cylindrical hollow body has a thickness of 0.1 to 20.0 mm, or 0.2 to 10.0 mm, or 0.3 to 6.5 mm, or 0.5 to 4.0 mm, or 0.5 to 2.0 mm. The wall thickness of the cylindrical hollow body may relate to or may match the first wall thickness WT1 and/or the second wall thickness WT2 of the at least one cross-sectional dimension of the hollow body. In some embodiments, the wall thickness is 0.1 mm or more, or 0.2 mm or more, or 0.3 mm or more, or 0.5 mm or more. In some embodiments, the wall thickness is 20.0 mm or less, or 10.0 mm or less, or 6.5 mm or less, or 4.0 mm or less, or 2.0 mm or less.

In some embodiments, the method comprises the further steps of:
Directing a second light beam along a second travel path from a second interferometric device towards the outer surface of the hollow body, and receiving a portion of light reflected at another tangential plane of the outer surface and a portion of light reflected at another tangential plane of the inner surface along the second travel path at the second interferometric device; and optionally
Directing a third light beam along a third travel path from a third interferometric device towards the outer surface of the hollow body and receiving a portion of light reflected at yet another tangential plane of the outer surface and a portion of light reflected at yet another tangential plane of the inner surface along the third travel path at the third interferometric device.

Advantageously, receiving portions of light reflected at three distinct tangential planes of the outer surface and receiving portions of light reflected at three distinct tangential planes of the inner surface offers the potential of simultaneous detections of the first wall thickness WT1 at three distinct locations of the hollow body. The hollow body has an inner cross-section and an outer cross-section, wherein the inner cross-section can be approximated as an inner ellipse, and wherein the outer cross-section can be approximated as an outer ellipse. The inner ellipse has an inner eccentricity. The outer ellipse has an outer eccentricity. According to this disclosure, the eccentricity e is calculated as

$$e = sqrt ( 1 - ( {b}^{2} / {a}^{2} ) ) ,$$

wherein a is the major axis of the ellipse, and wherein b is the minor axis of the ellipse. This configuration allows approximating and/or measuring the eccentricity e, as well as the length of the major axis a and the length of the minor axis b for both the inner ellipse and the outer ellipse of the hollow body.

In some embodiments, the method comprises the further steps of
Directing a fourth light beam along a fourth travel path from a fourth interferometric device towards the outer surface of the hollow body, and receiving a portion of light reflected at a further tangential plane of the outer surface and a portion of light reflected at a further tangential plane of the inner surface along the fourth travel path at the fourth interferometric device; and
Directing a fifth light beam along a fifth travel path from a fifth interferometric device towards the outer surface of the hollow body and receiving a portion of light reflected at yet a further tangential plane of the outer surface and a portion of light reflected at yet a further tangential plane of the inner surface along the fifth travel path at the fifth interferometric device.

Receiving portions of light reflected at five distinct tangential planes of the outer surface and receiving portions of light reflected at five distinct tangential planes of the inner surface further improves the potential of simultaneous detections of the first wall thickness WT1 at five distinct locations of the hollow body.

In some embodiments of the method, the travel path of the light beam directed towards the outer surface of the hollow body, the second travel path of the second light beam directed towards the outer surface of the hollow body, and the third travel path of the third light beam directed towards the outer surface of the hollow body, lie in the same geometrical plane.

In some embodiments of the method, the travel path of the light beam directed towards the outer surface of the hollow body, the second travel path of the second light beam directed towards the outer surface of the hollow body, and the third travel path of the third light beam directed towards the outer surface of the hollow body, each lie in mutually exclusive geometrical planes.

In some embodiments of the method, the travel path of the light beam directed towards the outer surface of the hollow body, the second travel path of the second light beam directed towards the outer surface of the hollow body, the third travel path of the third light beam directed towards the outer surface of the hollow body, the fourth travel path of the fourth light beam directed towards the outer surface of the hollow body, and the fifth travel path of the fifth light beam directed towards the outer surface of the hollow body, lie in the same geometrical plane.

In some embodiments of the method, at least two of the travel path of the light beam directed towards the outer surface of the hollow body, the second travel path of the second light beam directed towards the outer surface of the hollow body, the third travel path of the third light beam directed towards the outer surface of the hollow body, the fourth travel path of the fourth light beam directed towards the outer surface of the hollow body, and the fifth travel path of the fifth light beam directed towards the outer surface of the hollow body, lie in the same geometrical plane.

In some embodiments of the method, at least three of the travel path of the light beam directed towards the outer surface of the hollow body, the second travel path of the second light beam directed towards the outer surface of the hollow body, the third travel path of the third light beam directed towards the outer surface of the hollow body, the fourth travel path of the fourth light beam directed towards the outer surface of the hollow body, and the fifth travel path of the fifth light beam directed towards the outer surface of the hollow body, lie in the same geometrical plane.

In some embodiments of the method, at least four of the travel path of the light beam directed towards the outer surface of the hollow body, the second travel path of the second light beam directed towards the outer surface of the hollow body, the third travel path of the third light beam directed towards the outer surface of the hollow body, the fourth travel path of the fourth light beam directed towards the outer surface of the hollow body, and the fifth travel path of the fifth light beam directed towards the outer surface of the hollow body, lie in the same geometrical plane.

### Apparatus

In a second aspect, this disclosure provides an apparatus for measuring at least one cross-sectional dimension of a cylindrical hollow body, the apparatus comprising at least one interferometric device, and a scanner, wherein the scanner is arrangeable to direct an emitted light beam from the at least one interferometric device along a travel path towards an outer surface of the hollow body, the scanner being capable of varying an orientation of the travel path of the emitted light beam.

In a related aspect, this disclosure provides an apparatus for measuring at least one cross-sectional dimension of a cylindrical hollow body, the apparatus comprising at least one interferometric device, and a scanner, wherein the scanner is arrangeable to direct an emitted light beam from the at least one interferometric device along a travel path towards an outer surface of the hollow body, the scanner being configured to vary an orientation of the travel path of the emitted light beam.

The disclosed apparatus solves the problems of the prior art and provides a more reliable and more robust measurement of cylindrical hollow bodies.

According to the present disclosure, an interferometric device detects and analyzes properties of physical objects, e.g., cylindrical hollow bodies, by way of interference. To this end, for a single interferometric device, light from a single source is split into two or more reflected beams that travel in different optical paths, which are then combined again to produce interference. Both coherent and incoherent light sources can be used. The resulting interference pattern gives access to geometrical properties of the investigated physical objects.

According to the present disclosure, a scanner is an element that can realize a change in the beam direction in a specific angular range along a measuring axis. The scanner does not provide for a beam expansion. The measuring axis of the interferometric device sweeps through a relevant angular range with respect to the cylindrical hollow body by virtue of the scanner. If the measuring axis hits the outer surface of the hollow body, a portion of light reflected at the outer surface may be received and a portion of light reflected at the inner surface may be received along the travel path at the interferometric device. From the said two portions of light reflected at the outer surface and light reflected at the inner surface, a measurement of the first wall thickness WT1 can be obtained.

In some embodiments, the scanner is selected from the list of a piezoelectric scanner, a galvanometer scanner, a prism scanner and a MEMS mirror scanner. The scanner may be chosen such to provide a sufficient throughput of measurement values. In some embodiments, the scanner is operable at a mechanical scanning frequency between 10 and 1000 Hz, optionally between 200 and 300 Hz. In some embodiments, the scanner is operable at a data sampling frequency of up to 100 kHz, optionally between 60 to 70 KHz.

In some embodiments, the interferometric device is a Fizeau interferometer, a Mach-Zehnder interferometer, a Michelson interferometer or a Czerny-Turner spectrometer. Optionally the interferometric device is a Czerny-Turner spectrometer.

In some embodiments, the apparatus further comprises a focuser, and/or wherein the apparatus is mountable in relation to a conveyor suitable for conveying a cylindrical hollow body in a direction substantially parallel to the cylindrical hollow body's longitudinal axis.

In some embodiments, the focuser is selected from the list of a biconvex lens, a planoconvex lens, a cylindrical lens, and a compound lens.

In some embodiments, the conveyor is selected from the list of rails, rollers, belts, and a positioning frame.

In some embodiments, the apparatus further comprises a second interferometric device, a second scanner, and optionally a third interferometric device and a third scanner, wherein the second interferometric device, and the second scanner are functionally arranged in the same way as the interferometric device and the scanner in relation to another tangential plane of the outer surface of the hollow body, wherein, if present, the third interferometric device, and the third scanner are functionally arranged in the same way as the interferometric device and the scanner in relation to yet another tangential plane of the outer surface of the hollow body.

In some embodiments of the apparatus, the interferometric device, the scanner, the second interferometric device, the second scanner, the third interferometric device and the third scanner are arranged in one geometrical plane. This arrangement provides that several data points, i.e., values, in one cross-sectional dimension of the cylindrical hollow body may be measured. This arrangement thus provides access to receiving portions of light reflected at three distinct tangential planes of the outer surface and receiving portions of light reflected at three distinct tangential planes of the inner surface, from which simultaneous detections of the first wall thickness WT1 at three distinct locations of the hollow body may be made. This arrangement allows approximating and/or measuring the eccentricity e of the hollow body, as well as the length of the major axis a and the length of the minor axis b for both the inner ellipse and the outer ellipse of the hollow body.

In some embodiments, the interferometric device, the scanner, the second interferometric device, the second scanner, the third interferometric device and the third scanner are integrated into a single apparatus, optionally the apparatus provided according to this disclosure.

In some embodiments, the apparatus further comprises a fourth interferometric device, a fourth scanner, and optionally a fifth interferometric device and a fifth scanner, wherein the fourth interferometric device, and the fourth scanner are functionally arranged in the same way as the interferometric device and the scanner in relation to another tangential plane of the outer surface of the hollow body, wherein, if present, the fifth interferometric device, and the fifth scanner are functionally arranged in the same way as the interferometric device and the scanner in relation to yet another tangential plane of the outer surface of the hollow body.

In some embodiments of the apparatus, the interferometric device, the scanner, the second interferometric device, the second scanner, the third interferometric device, the third scanner, the fourth interferometric device, the fourth scanner, the fifth interferometric device and the fifth scanner are arranged in one geometrical plane.

In some embodiments, the interferometric device, the scanner, the second interferometric device, the second scanner, the third interferometric device, the third scanner, the fourth interferometric device, the fourth scanner, the fifth interferometric device and the fifth scanner are integrated into a single apparatus, optionally the apparatus provided according to this disclosure.

### Cylindrical Hollow Body

In a third aspect, this disclosure provides a cylindrical hollow body having a longitudinal axis, an outer surface and an inner surface, the hollow body having a first wall thickness WT1, an inner diameter ID, and a second wall thickness WT2, wherein the first wall thickness WT1, the inner diameter ID and the second wall thickness WT2 are measurable along any straight line which stands perpendicular on the longitudinal axis, and which straight line hypothetically cuts through the hollow body, wherein the hollow body has an outer diameter OD of 6 mm or less, wherein the hollow body has an inner diameter ID of 5 mm or less, wherein the absolute difference between the first wall thickness WT1 and the second wall thickness WT2 is less than 0.01 mm, or less than 0.005 mm, or less than 0.003 mm, or less than 0.001 mm and/or wherein the inner diameter has a tolerance of less than 0.01 mm, or less than 0.005 mm, or less than 0.003 mm, or less than 0.001 mm.

The approaches provided according to this disclosure allow for the first time the measurement of cylindrical hollow bodies with small diameters and thus enable an improved in-process control of the manufacturing of such cylindrical hollow bodies.

According to this disclosure, the absolute difference between the first wall thickness WT1 and the second wall thickness WT2 may be assessed for any data pair along any straight line which stands perpendicular on the longitudinal axis, and which straight line hypothetically cuts through the hollow body at any position.

In some embodiments, the absolute difference between the first wall thickness WT1 and the second wall thickness WT2 is less than 0.01 mm, or less than 0.007 mm, or less than 0.005 mm, or less than 0.003 mm, or less than 0.001 mm. In some embodiments, the absolute difference between the first wall thickness WT1 and the second wall thickness WT2 is at least 0.00001 mm, or at least 0.0001 mm.

According to this disclosure, the tolerance of the inner diameter is assessed for any straight line which stands perpendicular on the longitudinal axis, and which straight line hypothetically cuts through the hollow body at any position.

In some embodiments, the inner diameter has a tolerance of less than 0.01 mm, or less than 0.007 mm, or less than 0.005 mm, or less than 0.003 mm, or less than 0.001 mm. In some embodiments, the inner diameter has a tolerance of at least 0.0001 mm.

In some embodiments, the hollow body has an inner cross-section and an outer cross-section, wherein the inner cross-section can be approximated as an inner ellipse, and wherein the outer cross-section can be approximated as an outer ellipse, wherein the inner ellipse has an inner eccentricity of less than 0.1, or less than 0.03, or less than 0.01, wherein the outer ellipse has an outer eccentricity of less than 0.1, or less than 0.03, or less than 0.01.

In some embodiments, the inner ellipse has an inner eccentricity of at least 0.0001, or at least 0.0003, or at least 0.001. In some embodiments, the inner ellipse has an inner eccentricity of 0.0001 to 0.1, or 0.0003 to 0.03, or 0.001 to 0.01.

In some embodiments, the outer ellipse has an outer eccentricity of at least 0.0001, or at least 0.0003, or at least 0.001. In some embodiments, the outer ellipse has an outer eccentricity of 0.0001 to 0.1, or 0.0003 to 0.03, or 0.001 to 0.01.

### EXAMPLES

### Apparatus

An apparatus provided according to this disclosure was constructed using a scanner and scanner controller from Thorlabs (GVS011), a standard Windows 10 PC system, the software Chrocodile Explorer 1.3.5 (Precitec), a frequency generator TG120 (TTi) and a Chrocodile 2 IT 1300 (Precitec) as interferometer.

### Approach

The apparatus was arranged around the production line of a glass tube shortly before the glass tube is cut into single pieces: The apparatus was adjusted in such a way that the laser beam passes through the longitudinal axis of the glass tube with the scanner in neutral position while the glass tube section and the conveyor are arranged orthogonally to the laser beam. Then, the measurement was initiated.

### Measurements

The following glass tube dimensions were investigated (WT=wall thickness, OD=outer diameter): 1) WT=0.30 mm and OD=1.40 mm, 2) WT=0.40 mm and OD=1.25 mm, 3) WT=0.50 mm and OD=2.10 mm, 4) WT=0.65 mm and OD=1.85 mm, 5) WT=0.77 mm and OD=2.65 mm. The following parameters were directly accessible: i) at least one of the wall thicknesses WT1 and/or WT2, ii) the inner diameter ID, iii) the inner diameter ID and one of the wall thicknesses WT1 or WT2, iv) the outer diameter OD. The said parameters could be measured with a deviation of less than 0.005 mm with respect to the actual value. The actual value of the inner diameter ID was measured using a gauge.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for measuring at least one cross-sectional dimension of a cylindrical hollow body, the hollow body having a wall surrounding a lumen, a longitudinal axis, an inner surface and an outer surface, the method comprising:
providing the hollow body;
directing a light beam along a travel path from an interferometric device towards the outer surface of the hollow body, such that at least intermittently at least a portion of the light beam hits the outer surface of the hollow body;
receiving a portion of light reflected at the outer surface and receiving a portion of light reflected at the inner surface along the travel path at the interferometric device;
obtaining at least one cross-sectional dimension of the hollow body based on an interferometric measurement of the portion of light reflected at the outer surface and/or the portion of light reflected at the inner surface; and
varying an orientation of the travel path of the light beam towards the hollow body.

2. The method of claim 1, wherein the at least one cross-sectional dimension of the hollow body includes a first wall thickness.

3. The method of claim 2, wherein the at least one cross-sectional dimension of the hollow body also includes an inner diameter, a second wall thickness, and the outer diameter.

4. The method of claim 1, wherein the hollow body is a glass tube or a glass tube strand.

5. The method of claim 4, wherein the hollow body is conveyed from a production line in a direction substantially parallel to the longitudinal axis of the hollow body and conveying of the hollow body proceeds at a velocity between 0.001 and 6 m s⁻¹.

6. The method of claim 1, wherein the hollow body comprises or consists of a glass composition or a polymer material.

7. The method of claim 1, wherein the hollow body has a surface roughness on the outer surface and the inner surface of 1 nm to 5000 nm determined according to ISO 25178-2:2012.

8. The method of claim 1, wherein the light beam is a focused light beam which is focused on the outer surface of the hollow body.

9. The method of claim 1, wherein directing the light beam is effected by a scanner which is operable at a mechanical scanning frequency between 10 and 1000 Hz and/or the scanner is operable at a data sampling frequency of up to 100 kHz.

10. The method of claim 1, wherein obtaining the at least one cross-sectional dimension of the hollow body comprises recording a timestamp for each value obtained.

11. The method of claim 1, wherein the wall of the hollow body has a thickness of 0.1 to 20.0 mm.

12. The method of claim 1, further comprising directing a second light beam along a second travel path from a second interferometric device towards the outer surface of the hollow body, and receiving a portion of light reflected at another tangential plane of the outer surface and a portion of light reflected at another tangential plane of the inner surface along the second travel path at the second interferometric device.

13. The method of claim 12, further comprising directing a third light beam along a third travel path from a third interferometric device towards the outer surface of the hollow body and receiving a portion of light reflected at yet another tangential plane of the outer surface and a portion of light reflected at yet another tangential plane of the inner surface along the third travel path at the third interferometric device.

14. An apparatus for measuring at least one cross-sectional dimension of a cylindrical hollow body, the apparatus comprising:
at least one interferometric device; and
a scanner that is arrangeable to direct an emitted light beam from the at least one interferometric device along a travel path towards an outer surface of the hollow body, wherein the scanner is capable of varying an orientation of the travel path of the emitted light beam.

15. The apparatus of claim 14, wherein the scanner is selected from the group consisting of a piezoelectric scanner, a galvanometer scanner, a prism scanner and a MEMS mirror scanner, and/or wherein the at least one interferometric device is a Fizeau interferometer, a Mach-Zehnder interferometer, a Michelson interferometer or a Czerny-Turner spectrometer.

16. The apparatus of claim 14, further comprising a focuser, and/or wherein the apparatus is mountable in relation to a conveyor suitable for conveying a cylindrical hollow body in a direction substantially parallel to a longitudinal axis of the hollow body.

17. The apparatus of claim 14, further comprising a second interferometric device and a second scanner, wherein the second interferometric device and the second scanner are functionally arranged in the same way as the at least one interferometric device and the scanner in relation to another tangential plane of the outer surface of the hollow body.

18. A cylindrical hollow body having a longitudinal axis, an outer surface and an inner surface, the hollow body having a first wall thickness (WT1), an inner diameter (ID), and a second wall thickness (WT2), wherein the first wall thickness WT1, the inner diameter ID, and the second wall thickness WT2 are measurable along any straight line which stands perpendicular on the longitudinal axis, and which straight line hypothetically cuts through the hollow body, the hollow body having an outer diameter (OD) of 6 mm or less and the inner diameter is 5 mm or less, wherein an absolute difference between the first wall thickness WT1 and the second wall thickness WT2 is less than 0.01 mm and/or the inner diameter ID has a tolerance of less than 0.01 mm.

19. The hollow body of claim 18, comprising an inner cross-section and an outer cross-section, wherein the inner cross-section can be approximated as an inner ellipse, and wherein the outer cross-section can be approximated as an outer ellipse, wherein the inner ellipse has an inner eccentricity of less than 0.1, wherein the outer ellipse has an outer eccentricity of less than 0.1.
